(19) United States
(12) Patent Application Publication
(10) Pub. No.: US 2026/0228003 A1
(43) Pub. Date: Aug. 6, 2026

(54) TECHNIQUES FOR DYNAMICALLY PADDING DATA

(71) Applicant: NVIDIA CORPORATION, Santa Clara, CA (US)

(72) Inventors: Rangharajan VENKATESAN, San Jose, CA (US); Benjamin Andrew KELLER, Oakland, CA (US); Thierry TAMBE, Palo Alto, CA (US)

(21) Appl. No.: 19/043,357

(22) Filed: Jan. 31, 2025

(51) Int. Cl. G06F 9/30; G06T 1/60

(52) U.S. Cl. CPC G06F 9/30043; G06F 9/30101; G06T 1/60

(57) ABSTRACT

One embodiment of a method for padding data includes storing one or more memory addresses at which padding is to be added in a queue; determining whether a first memory address is stored in the queue; if the first memory address is stored in the queue, then writing a zero to a register; if the first memory address is not stored in the queue, then writing a first value that is read from a first memory to the register; and performing at least one computation based on the first value that is written to the register to generate an output.

### BACKGROUND

### Field of the Various Embodiments

The various embodiments relate generally to computer science and computer memory and, more specifically, to techniques for dynamically padding data.

### Description of the Related Art

“Padding” refers to the extra values, such as zeroes or other neutral values that do not affect the results of a computation, that are added to data for various purposes. Adding padding to data is also referred to as “padding the data.”

In machine learning, padding is oftentimes added to the weight tensors that represent different layers of an artificial neural network as well as to activation values that are input into the different layers. Padding the weight tensors and activation values can improve parallel processing and reduce computational overhead when executing the neural network. For example, specialized circuitry for performing the computations of a neural network can process data having a minimum length to achieve higher levels of energy efficiency. Input data that is smaller than the minimum length, or that cannot be divided evenly by the minimum length, can be padded to reach the minimum length required by the specialized circuitry in order to achieve better computational energy efficiency.

One conventional approach for padding data is to read all of the data that needs to be padded from memory and then add padding to that data once all of the data has been retrieved. With this approach, processing operations typically begin only after all of the data has been properly retrieved and padded. One drawback of this approach, though, is that, because padding is added to the data only after all of the data has been read from memory, some of the data cannot be processed immediately after being read from memory. Accordingly, with this approach to padding, data processing can be delayed, particularly when the data is large in size and takes a significant amount of time to read from memory. Another drawback is that additional storage is required to store both the entire set of data that has been read from memory and the fully padded values. In some cases, the number of padded values can be many times the size of the data itself and require a significant amount of storage.

One reason why data cannot be immediately padded and processed upon retrieval from memory is that the data typically needs to be ordered correctly for the processing to be performed correctly. Notably, few, if any, effective techniques currently exist for guaranteeing the correct ordering of data that is read from memory, particularly when padding is added to such data.

As the foregoing illustrates, what is needed in the art are more effective techniques for padding data as the data is retrieved from memory.

### SUMMARY

One embodiment of the present disclosure sets forth a method for padding data. The method includes storing one or more memory addresses at which padding is to be added in a queue. The method also includes determining whether a first memory address is stored in the queue. The method further includes, if the first memory address is stored in the queue, then writing a zero to a register, and if the first memory address is not stored in the queue, then writing a first value that is read from a first memory to the register. In addition, the method includes performing at least one computation based on the first value that is written to the register to generate an output.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is that, with the disclosed techniques, data is ordered correctly when the data is read from memory and padded. Accordingly, computations can be performed on padded data as data is read from memory and padding is added to the data. In addition, the disclosed techniques permit multiple outstanding data access requests to memory as padding is being added, which can hide memory access latency. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 illustrates a system-on-chip that can be included in the parallel processing subsystem of FIG. 1, according to various embodiments;

FIG. 5 illustrates how a neural network can be executed on the system-on-chip of FIG. 4, according to various embodiments;

FIG. 6A illustrates an exemplar padding of weights from a layer of a neural network, according to various embodiments;

FIG. 6B illustrates an exemplar padding of input activations, according to various embodiments;

FIG. 7 illustrates how the AI accelerator of FIG. 4 adds padding while maintaining the sequential order of data, according to various embodiments; and

FIG. 8 is a flow diagram of method steps for performing dynamic padding, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for dynamic padding. In some embodiments, an artificial intelligence (AI) accelerator generates a memory address and checks whether the memory address is a padding address. If the memory address is not a padding address, then the AI accelerator sends, to a memory, a read request to read data at the memory address. On the other hand, if the memory address is a padding address, then the AI accelerator pushes the address to a padding FIFO (first-in-first-out), which can be a queue that stores such addresses. Subsequently, when writing to a read register, in order to ensure the correct ordering of data being read from memory, the AI accelerator determines if a next address is a padding address by inspecting the first element of the padding FIFO. If the next address is a padding address, then the AI accelerator writes a 0 to the read register. On the other hand, if the next address is not a padding address, then the AI accelerator writes a value in a read response from the memory to the read register. If the read response is delayed, then the AI accelerator stalls until the read response is received.

The techniques for dynamic padding of the present disclosure have many real-world applications. For example, the techniques can be used to pad the weight tensors of neural networks. As another example, the techniques can be used to pad input activations into the layers of neural networks.

The above examples are not in any way intended to be limiting. As persons skilled in the art will appreciate, as a general matter, the techniques for dynamic padding described herein can be implemented anywhere that padding is required or useful.

### System Overview

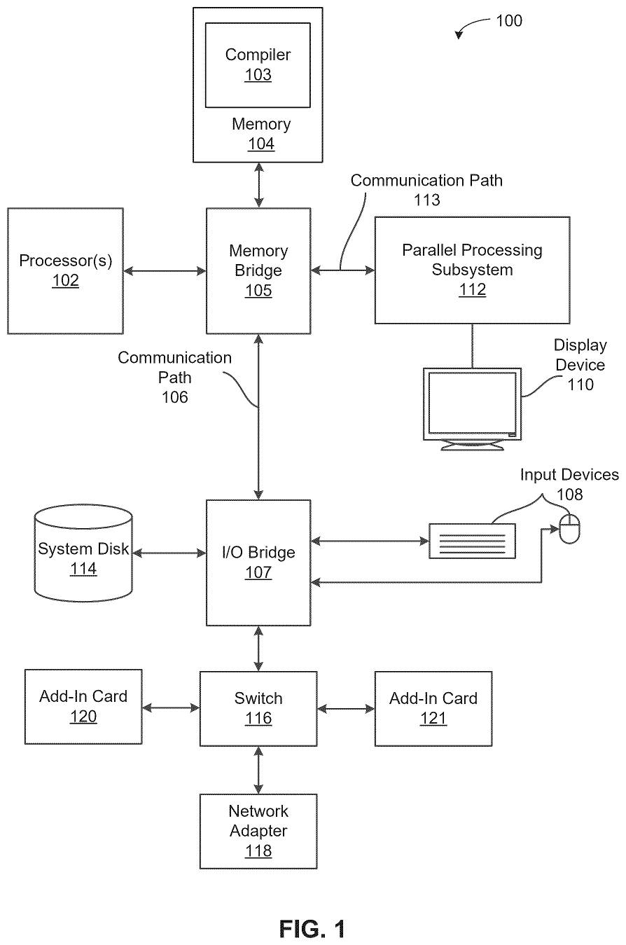

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

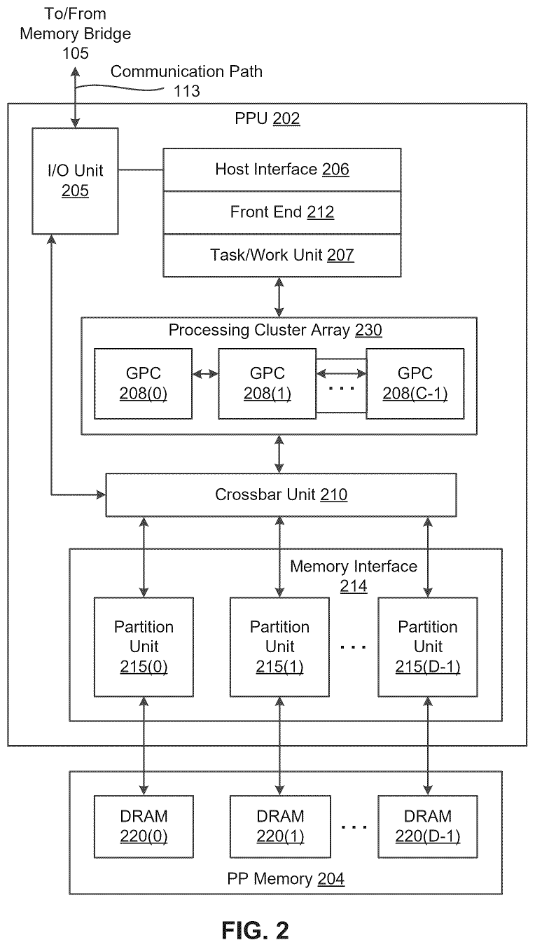

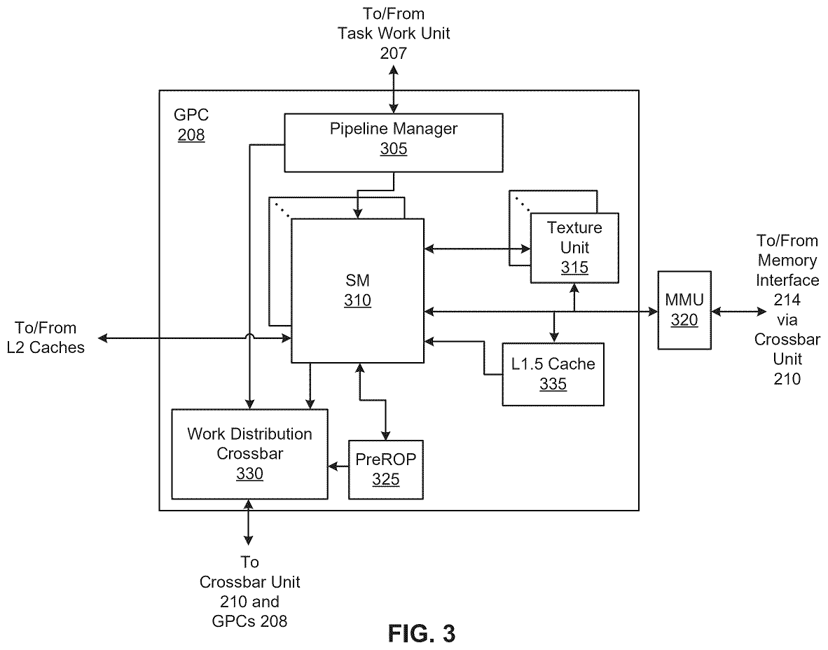

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

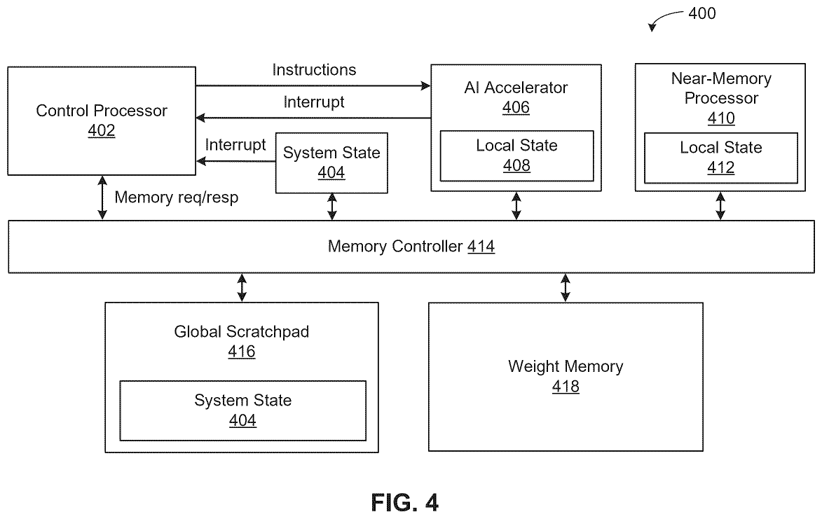

Illustratively, system memory 104 stores a compiler 103 and a runtime system 132. Compiler 103 is configured to translate source code in a human-readable programming language into machine code that can be executed by a computer. In some embodiments, compiler 103 can translate the source code for computations performed by a neural network into machine code that can be executed using the system-on-chip discussed below in conjunction with FIGS. 4-8. Although described herein primarily with respect to the compiler 103 as reference examples, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### System-on-Chip for Accelerating AI Workloads

FIG. 4 illustrates a system-on-chip (SoC) 400 that can be included in the parallel processing subsystem of FIG. 1, according to various embodiments. As shown, the SoC 400 includes a control processor 402, an artificial intelligence (AI) accelerator 406, a near-memory processor 410, a memory controller 414, a global scratchpad 416, and a weight memory 418.

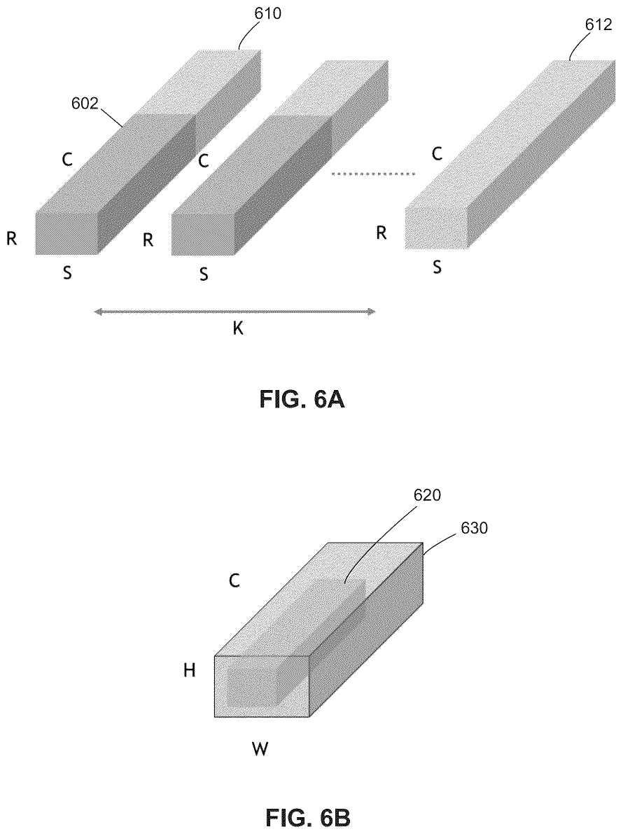

The AI accelerator 406 is a specialized hardware accelerator that includes circuitry for accelerating AI and machine learning applications, such as training and inferencing using artificial neural networks. Components of the AI accelerator 406 are discussed in greater detail below in conjunction with FIG. 6. Illustratively, the AI accelerator 406 maintains a local state 408 of the AI accelerator 406.

The near-memory processor 410 is a processor that improves performance of certain operations by moving the computing capability closer to the global scratchpad 416. For example, certain operations (e.g., pooling operations) do not have much re-use and can be performed by reading data from the global scratchpad 416, performing the requisite computations, and then writing the results back to the global scratchpad 416, without moving the data a further distance to the AI accelerator 406. By minimizing the movement of data, the near-memory processor 410 can reduce latency and power consumption. Illustratively, the near-memory processor 410 maintains a local state 412 of the near-memory processor 410. In some embodiments, certain memory operations that can be efficiently handled by address generators rather than the near-memory processor 410 or the AI accelerator 406.

The control processor 402 manages the flow of data and operations across components of the SoC 400. In some embodiments, the control processor 402 issues instructions that are executed by the AI accelerator 406 and the near-memory processor 410. For example, the instructions could be for the AI accelerator 406 and/or the near-memory processor 410 one or more layers of a neural network. In such cases, when the execution is completed, the AI accelerator 406 and/or the near-memory processor 418 can transmit interrupts to the control processor 402, notifying the control processor 402 that the execution is completed.

The global scratchpad 416 and the weight memory 418 are level 2 (L2) memories used to store frequently accessed data and instructions to speed up processing by reducing the need to access main memory as often. The weight memory 418 is a storage for parameters of a neural network. For example, in some embodiments, the weight memory 418 can be used to store the weights in one or more layers of a neural network. The global scratchpad 416 is a temporary storage for data during calculations involving a neural network. For example, in some embodiments, the global scratchpad 416 can store (1) input activations that are input into one or more layers of a neural network, and (2) output activations that are output by one or more layers of a neural network, for one or more layers of the neural network during training and/or inference operations. Illustratively, the global scratchpad 416 also stores a system state 404 of the SoC 400.

The memory controller 414 manages data flow between the processors, including the control processor 402, the AI accelerator 406, and the near-memory processor 401 and the memory, including the global scratchpad 416 and the weight memory 418.

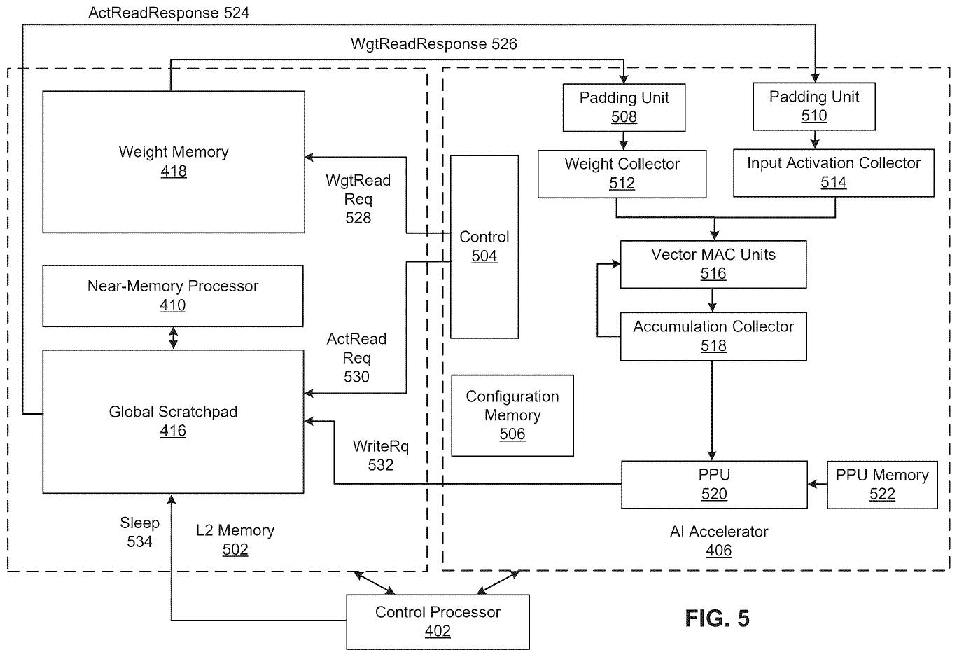

FIG. 5 illustrates how a neural network can be executed on the SoC 400 of FIG. 4, according to various embodiments. As shown, the AI accelerator 406 includes control logic 504, a configuration memory 506, padding units 508 and 510, a weight collector 512, an input activation collector 514, vector multiply-accumulate (MAC) units 516, an accumulation collector 518, a post-processing unit (PPU) 520, and a PPU memory 522.

As described, the control processor 402 manages the flow of data and operations across components of the SoC 400 by issuing instructions that are executed by the AI accelerator 406 and the near-memory processor 410. For example, the control processor 402 could issue instructions for the AI accelerator 406 to execute one or more layers of a neural network, such as a batch of back-to-back layers of the neural network, and then return control to the control processor 402. In such a case, the instructions can be stored in the configuration memory 506. In addition, the control processor 402 can control the sleep states of memory banks within the global scratchpad 416 and the weight memory 418. In some embodiments, the control processor 402 activates only the memory bank(s) storing data that is required to execute the one or more layers of the neural network, thereby switching such memory bank(s) to an “active state,” while maintaining the remaining memory bank(s) in other states that consume less leakage power. For example, memory banks storing data that needs to be used in the future could be switched to a “retention” state that consumes less leakage power than the “active” state, while memory banks that do not store any data related to the neural network can be switched to an “idle” state that consumes less leakage power than the “active” state and the “retention” state. In some embodiments, the control processor 402 can issue commands to the global scratchpad 416 and the weight memory 418 to switch the states of memory banks therein.

The control logic 504 includes circuitry that reads instructions from the configuration memory 506 and causes the instructions to be executed by the AI accelerator 406 and/or the near-memory processor 410. Illustratively, after reading instructions from the configuration memory 506 to execute one or more layers of a neural network, the control logic 504 transmits (1) requests to read input activations, shown as activation read request 530, to the global scratchpad 416, and (2) requests to read weights for the layer(s) of the neural network, shown as weight read request 528, to the weight memory 418. In response to such requests, the global scratchpad 416 returns activation read responses, shown as activation read response 524, to the AI accelerator 406, and the weight memory 418 returns weight read responses, shown as weight read response 526, to the AI accelerator 406.

Padding units 508 and 510 include circuitry configured to add padding to the activations in the activation read response 524 and the weights in the weight read response 526, respectively. In some embodiments, the padding includes zeros that are added when the vector MAC units 516 require inputs of a particular length, but the activations and/or weights have a different length. For example, when the vector MAC units 516 require vectors of length 32 as input, but the activations have a length of 8, then the padding unit 510 could pad each activation with 24 zeroes. As another example, when the vector MAC units 516 require images of a particular size as input, but the activations include smaller images, then the padding unit 510 could pad borders of the smaller images with zeroes. Another example is a convolution operation with 3×3 kernels, where the computation requires adding zeros along the border, which is independent of the size/length of the vector MAC units 516. Padding eliminates the need to store the zeroes explicitly in memory, which can save memory space.

The weight collector 512 is a memory that stores weights after any necessary padding has been added to weights in the weight response 526 by the padding unit 508. The input activation collector 514 is a memory that stores input activations after any necessary padding has been added to activations in the activation read response 524.

The vector MAC units 516 are specialized hardware that include circuitry for performing multiply-accumulate operations on multiple data elements simultaneously, allowing for faster processing of large datasets according to the Single Instruction, Multiple Data (SIMD) paradigm. In particular, the vector MAC units 516 can perform multiply-accumulate operations using the weights and input activations with (optional) padding that is stored in the weight collector 512 and the input activation collector 514, respectively. For example, the multiply-accumulate operations could involve multiplying weights by input activations, dynamically generating weights and activations, and/or the like.

The accumulation collector 518 gathers intermediate calculation results from the vector MAC units 516 and accumulates the intermediate results together. In some embodiments, accumulating the intermediate results can include summing the intermediate results.

The PPU 520 performs post processing of the accumulated output. Any technically feasible post processing operations can be performed in some embodiments. In some embodiments, the post processing can include data format conversion operations and/or non-linear operations. For example, accumulated output that is 32 bits could be converted to 4 or 8 bits to save memory space. As another example, non-linear operations, such as tanh or sigmoid operations, could be performed on the accumulated output. The PPU memory 522 is a memory coupled to the PPU 520.

In operation, to execute a layer of a neural network, (1) weights of the layer and input activations are streamed from the weight memory 418 and the global scratchpad 416, respectively, into the AI accelerator 406; (2) the padding units 510 and 508 add any necessary padding to the input activations and the weights, respectively, after which the results are stored in the input activation collector 514 and the weight collector 512, respectively; (3) the vector MAC units 516 performs multiply-accumulate operations using the stored input activations and weights with (optional) padding that are stored in the input activation collector 514 and the weight collector 512, respectively, to generate intermediate results; (4) the accumulation collector 518 gathers the intermediate calculation results from the vector MAC units 516 and accumulates the intermediate results together; (5) the PPU 520 performs post processing on the accumulated output of the accumulation collector 518; and (5) output of the PPU 512 can be written back to the global scratchpad 416 as output activations, as described above. The foregoing steps can be repeated to execute multiple layers of a neural network.

When one or more layers are to be executed by the near-memory processor 410, the control processor 402 can similarly configure the near-memory processor 410 to execute the layers sequentially. As described, the near-memory processor 410 is a processor that improves performance of certain operations by moving the computing capability closer to the global scratchpad 416. For example, certain operations do not have much re-use and can be performed by reading data from the global scratchpad 416, performing the requisite computations, and then writing the results back to the global scratchpad 416, without moving the data a further distance to the AI accelerator 406.

### Dynamically Padding Data

FIGS. 6A-6B illustrate different scenarios in which values can be padded prior to input into the vector MAC units 516. FIG. 6A illustrates an exemplar padding of weights from a layer of a neural network, according to various embodiments. As shown, a weight tensor 602 has been padded along a channel dimension C with padding 610 when the number of input channels for a layer of a neural network is fewer than the input length of the vector MAC units 516. The padding 610 can includes zeroes that are added to weight tensor 602 to make the number of input channels plus the padding equal to the input length of the vector MAC units 516. Padding can be useful when the vector MAC units 516 act on a minimum kernel length (e.g., 16 by 32) to achieve relatively high energy efficiency, but data being input into the vector MAC units 516 is smaller than the minimum kernel length or cannot be divided evenly by the minimum kernel length, leaving a remainder that is smaller than the minimum kernel length. In some embodiments, padding can be added and fed into the data path along with input data to reach the minimum kernel length of the vector MAC units 516. Padding with zeroes will not affect the output of the vector MAC units 516. Although described herein primarily with respect to padding with zeroes as a reference example, in some embodiments, values other than zero can be used when such values are “neutral” and do not affect the output of operations being performed.

Further, the padding can be added prior to performing computations using the vector MAC units 516 to avoid storing the padded zeroes explicitly, which would waste memory space and increase the leakage power.

Illustratively, padding 612 has also been added along the K dimension, which corresponds to the number of vector MAC units 516. In some embodiments, padding along the K dimension can be added when there are extra vector MAC units 516 whose parallelism cannot be exploited.

FIG. 6B illustrates an exemplar padding of input activations, according to various embodiments. As shown, padding 630 can be added to an input activation tensor 620 having dimensions H, W, and C along the height dimension H, the width dimension W, and/or the channel dimension C. For example, the input activation tensor 620 can be an image on which a convolution is to be performed. Similar to the padding 610 and 612, described above in conjunction with FIG. 6A, the padding 630 can include zeroes that are added to make the length of the tensor 620 plus the padding equal to an input length of the vector MAC units 516.

That is, in some embodiments, to reduce the memory overheads of storing redundant zero-valued data, the AI accelerator 406 can perform dynamic padding along different dimensions of weight and activation tensors. Although described herein primarily with respect to padding weights and input activations as reference examples, techniques disclosed herein can be applied to pad any suitable data in some embodiments.

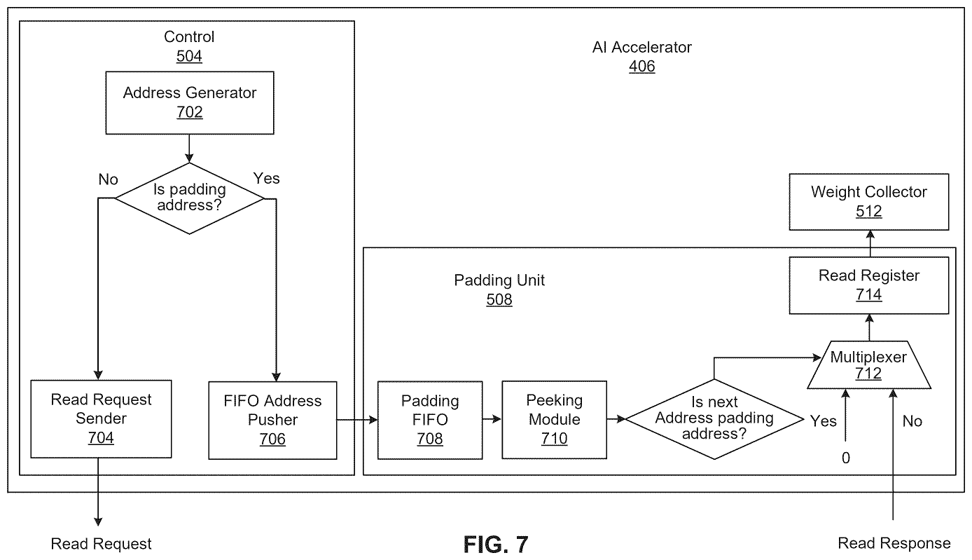

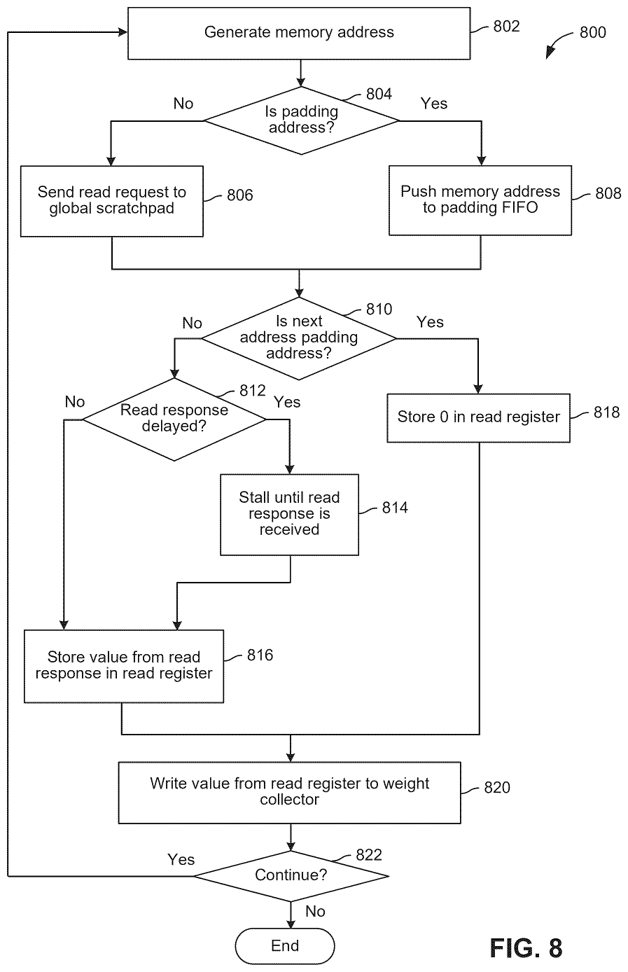

FIG. 7 illustrates how the AI accelerator 406 adds padding while maintaining the sequential order of data, according to various embodiments. As shown, the control logic 504 includes an address generator 702, a read request sender 704, and a first-in-first-out (FIFO) address pusher 706. In addition, the padding unit 508 includes a padding FIFO 708, a peeking module 710, a multiplexer 712, and a read register 714. The address generator 702 generates a memory address, from which a weight value can be read from the weight memory 418. Although FIGS. 7-8 are described primarily with respect to padding weight values read from the weight memory 418 as a reference example, in some embodiments, input activations into one or more layers of a neural network can be padded in a similar manner. The control logic 504 checks whether the memory address is a padding address or not. In some embodiments, the control logic 504 can read, from the configuration memory 506, dimensions of the neural network layer to be executed and determine if the memory address is outside of such dimensions, meaning the memory address is a padding address. In such cases, the dimensions of the neural network layer can be written to the configuration memory 506 by the control processor 402 that instructs the AI accelerator 406 to process the layer when control processor 402 executes machine code that is compiled from source code by the compiler 103. Further, when the compiler 103 generates a workload by compiling source code into machine code, the compiler 103 can indicate, in the machine code, where padding needs to be added in order for computations in the workload to be performed correctly. In some embodiments, in addition to the dimensions of the neural network layer, the control processor 402 can also write, to the configuration memory 506, pad_c, pad_k, etc. values that indicate the number of values to be padded, which can vary depending on other runtime parameters such as precision.

If the memory address is not a padding address, then the read request sender 704 sends, to the weight memory 418, a read request to read data at the memory address. The weight memory 418 will return a response to the read request after some time due to latency. On the other hand, if the memory address is not a padding address, then the FIFO address pusher 706 pushes the address to the padding FIFO 708. In some embodiments, the padding FIFO 708 can be a queue that stores a list of addresses that need to be padded with zeros while read requests to the weight memory 418 are outstanding. Either the full addresses can be stored in the padding FIFO 708, or a more compact representation of the addresses, such as the least significant bits of the addresses, can be stored in the padding FIFO 708 to reduce the width of the padding FIFO 708. The control logic 504 sends read requests to the weight memory 418 only when the memory addresses belong to non-padded regions. Otherwise, when memory addresses belong to padded regions, the memory addresses are queued in the padding FIFO 708. Using the padding FIFO 708 to keep track of addresses at which padding needs be added permits multiple read requests to be sent to the weight memory 418 without stalling. As a result, multiple read requests can be outstanding, improving throughput and hiding the latency associated with responses to the read requests. It is assumed that the responses to the read requests come back in the same order that the read requests are issued.

When writing to the read register 714, in order to ensure the correct ordering of data being read from memory, the padding unit 508 determines if a next address to be written to the weight collector 512, which can be a level one (L1) memory, is a padding address by using peeking module 710 to inspect the first address stored in the padding FIFO 708. If the next address matches the first address, indicating that the next address is a padding address, then the padding unit 508 writes a 0 to the read register 714 via the multiplexer 712. The 0 is further written to the weight collector 512. On the other hand, if the next address is not a padding address, then the padding unit 508 writes a value in a read response from the weight memory 418 to the read register 714 via the multiplexer 712. The value is further written to the weight collector 512. It should be noted that data is always written to the weight collector 512 in the correct order. Because the data stored in the weight collector 512 is in the correct order, such data can be processed as soon as the data becomes available in the weight collector 512, without waiting for other data to be read. If the read response from the weight memory 418 is delayed, then the padding unit 508 stalls until the read response is received. In some embodiments, as read responses are received from the weight memory 418, the padding unit 508 checks the padding FIFO 708 to insert appropriate padding values into the read register 714 before the values from the read responses, and then stores the padding and values in the weight collector 512. That is, to ensure correct ordering of data, the padding FIFO 708 is used to insert padded values into the read register 714 before the values are written to the weight collector 512. Further, multiple outstanding requests are supported in order to hide weight memory 418 access latency while simultaneously avoiding the overhead of sending addresses along with responses. The overhead of sending addresses along with responses arises because, without the padding FIFO 708 to keep track of the correct sequence of transactions, the weight memory 418 would have to keep track of the address associated with each read request and send that address back alongside the read response. Doing so would impose overhead of more data movement (sending the address), plus overhead of additional logic for the AI accelerator 406 to read the address and determine where to store the data.

FIG. 8 is a flow diagram of method steps for performing dynamic padding, according to various embodiments. Although the method steps are described in conjunction with FIGS. 1-5, persons skilled in the art will understand that any system configured to perform the method steps, in any order, falls within the scope of the present disclosure.

As shown, a method 800 begins at step 802, where the AI accelerator 406 generates a memory address. The memory address is generated for reading a weight value from the weight memory 418.

At step 804, if the memory address is not a padding address, then the method 800 continues to step 806, where the AI accelerator 406 sends, to the weight memory 418, a read request to read data at the memory address. As described, in some embodiments, the control logic 504 can read, from the configuration memory 506, dimensions of a neural network layer to be executed and determine if the memory address is outside of such dimensions, meaning the memory address is a padding address. In such cases, the control logic 504 sends a read request to the weight memory 418 only when the memory address belongs to a non-padded region, and the weight memory 418 will return a response to the read request after some time due to latency. In some embodiments, in addition to the dimensions of the neural network layer, the control logic 504 can also read from the configuration memory 506, pad_c, pad_k, etc. values that indicate the number of values to be padded, which can vary depending on other runtime parameters such as precision.

On the other hand, if the memory address is a padding address, then at step 808, the AI accelerator 406 pushes the address to the padding FIFO 708. In some embodiments, the padding FIFO 708 is a queue that stores a list of addresses that need to be padded with zero while read requests to the weight memory 418 are outstanding. Either the full addresses can be stored in the padding FIFO 708, or a more compact representation of the addresses, such as the least significant bits of the addresses, can be stored in the padding FIFO 708 to reduce the width of the padding FIFO 708.

At step 810, if a next address to be written to the weight collector 512, which can be a L1 memory, is a padding address, then the method 800 continues to step 812. In some embodiments, the AI accelerator 406 peeks at a first address stored in the padding FIFO 708 to determine whether the next address matches the first address, indicating that the next address is a padding address at which a zero should be written.

At step 812, if a read response is delayed, then the method 800 continues to step 814, where the AI accelerator 406 stalls until the read response is received.

On the other hand, if the read response is not delayed, or after the padding units 508 stalls at step 814, then the method 800 proceeds to step 816, where the AI accelerator 406 stores a value from the read response in the read register 714. Additionally, if the AI accelerator 406 determines that the next address is a padding address at step 810, then the method 800 proceeds directly to step 818, where the AI accelerator 406 stores a 0 in the read register 714.

At step 820, the AI accelerator 406 writes the value stored in the read register 714 to the weight collector 512, which as described can be an L1 memory in some embodiments. It should be noted that data is always written to the weight collector 512 in a correct order. Because the data stored in the weight collector 512 is in the correct order, such data can be processed as soon as the data becomes available in the weight collector 512, without waiting for other data to be read.

At step 822, if the AI accelerator 406 determines to continue reading and padding weight values for processing, then the method 800 returns to step 802, where the AI accelerator 406 generates another memory address. On the other hand, if the AI accelerator 406 determines not to continue, then the method 800 ends.

In sum, techniques are disclosed for dynamic padding. In some embodiments, an AI accelerator generates a memory address and checks whether the memory address is a padding address. If the memory address is not a padding address, then the AI accelerator sends, to a memory, a read request to read data at the memory address. On the other hand, if the memory address is a padding address, then the AI accelerator pushes the address to a padding FIFO, which can be a queue that stores such addresses. Subsequently, when writing to a read register, in order to ensure the correct ordering of data being read from memory, the AI accelerator determines if a next address is a padding address by inspecting the first element of the padding FIFO. If the next address is a padding address, then the AI accelerator writes a 0 to the read register. On the other hand, if the next address is not a padding address, then the AI accelerator writes a value in a read response from the memory to the read register. If the read response is delayed, then the AI accelerator stalls until the read response is received.

One technical advantage of the disclosed techniques relative to the prior art is that, with the disclosed techniques, data is ordered correctly when the data is read from memory and padded. Accordingly, computations can be performed on padded data as data is read from memory and padding is added to the data. In addition, the disclosed techniques permit multiple outstanding data access requests to memory as padding is being added, which can hide memory access latency. These technical advantages provide one or more technological improvements over prior art approaches.
1. In some embodiments, a computer-implemented method for padding data comprises storing one or more memory addresses at which padding is to be added in a queue, determining whether a first memory address is stored in the queue, if the first memory address is stored in the queue, then writing a zero to a register, if the first memory address is not stored in the queue, then writing a first value that is read from a first memory to the register, and performing at least one computation based on the first value that is written to the register to generate an output.
2. The computer-implemented method of clause 1, further comprising generating a second memory address, determining whether padding is to be added at the second memory address, if padding is to be added at the second memory address, then adding the second memory address to the queue, and if padding is not to be added at the second memory address, then requesting a second value that is stored at the second memory address from the first memory.
3. The computer-implemented method of clauses 1 or 2, wherein determining whether the second memory address is associated with padding comprises determining whether the second memory address is outside at least one dimension of a tensor.
4. The computer-implemented method of any of clauses 1-3, further comprising stalling until a response that includes the second value is received from the first memory.
5. The computer-implemented method of any of clauses 1-4, wherein the second value is requested while a request for a third value from the first memory is outstanding.
6. The computer-implemented method of any of clauses 1-5, further comprising writing the first value that is stored in the register to a second memory.
7. The computer-implemented method of any of clauses 1-6, wherein the first value is included in a tensor of weights representing a layer included in a trained neural network.
8. The computer-implemented method of any of clauses 1-7, wherein the first value is included in a tensor representing an input into a layer included in a trained neural network.
9. The computer-implemented method of any of clauses 1-8, wherein the first memory comprises a scratchpad memory.
10. The computer-implemented method of any of clauses 1-9, wherein storing the one or more memory addresses in the queue comprises storing one or more bits associated with the one or more memory addresses in the queue.
11. In some embodiments, a processor comprises a first memory, and circuitry configured to store one or more memory addresses at which padding is to be added in a queue, determine whether a first memory address is stored in the queue, if the first memory address is stored in the queue, then write a zero to a register, if the first memory address is not stored in the queue, then write a first value that is read from the first memory to the register, and perform at least one computation based on the first value that is written to the register to generate an output.
12. The processor of clause 11, wherein the circuitry is further configured to generate a second memory address, determine whether padding is to be added at the second memory address, if padding is to be added at the second memory address, then add the second memory address to the queue, and if padding is not to be added at the second memory address, then request a second value that is stored at the second memory address from the first memory.
13. The processor of clauses 11 or 12, wherein determining whether the second memory address is associated with padding comprises determining whether the second memory address is outside at least one dimension of a tensor.
14. The processor of any of clauses 11-13, wherein the circuitry is further configured to stall until a response that includes the second value is received from the first memory.
15. The processor of any of clauses 11-14, wherein the second value is requested while a request for a third value from the first memory is outstanding.
16. The processor of any of clauses 11-15, further comprising a second memory, wherein the circuitry is further configured to write the first value that is stored in the register to the second memory.
17. The processor of any of clauses 11-16, wherein the first memory comprises a scratchpad memory, and the second memory comprises a level one (L1) memory.
18. The processor of any of clauses 11-17, wherein the first value is included in either a first tensor of weights representing a layer included in a trained neural network or a second tensor representing an input into the layer.
19. The processor of any of clauses 11-18, wherein the processor comprises a graphics processing unit (GPU).
20. In some embodiments, a system comprises a memory, and a processor that is coupled to the memory and configured to perform the steps of storing one or more memory addresses at which padding is to be added in a queue, determining whether a first memory address is stored in the queue, if the first memory address is stored in the queue, then writing a zero to a register, if the first memory address is not stored in the queue, then writing a value that is read from the memory to the register, and performing at least one computation based on the value that is written to the register to generate an output.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for padding data, the method comprising:
storing one or more memory addresses at which padding is to be added in a queue;
determining whether a first memory address is stored in the queue;
if the first memory address is stored in the queue, then writing a zero to a register;
if the first memory address is not stored in the queue, then writing a first value that is read from a first memory to the register; and
performing at least one computation based on the first value that is written to the register to generate an output.

2. The computer-implemented method of claim 1, further comprising:
generating a second memory address;
determining whether padding is to be added at the second memory address;
if padding is to be added at the second memory address, then adding the second memory address to the queue; and
if padding is not to be added at the second memory address, then requesting a second value that is stored at the second memory address from the first memory.

3. The computer-implemented method of claim 2, wherein determining whether the second memory address is associated with padding comprises determining whether the second memory address is outside at least one dimension of a tensor.

4. The computer-implemented method of claim 2, further comprising stalling until a response that includes the second value is received from the first memory.

5. The computer-implemented method of claim 2, wherein the second value is requested while a request for a third value from the first memory is outstanding.

6. The computer-implemented method of claim 1, further comprising writing the first value that is stored in the register to a second memory.

7. The computer-implemented method of claim 1, wherein the first value is included in a tensor of weights representing a layer included in a trained neural network.

8. The computer-implemented method of claim 1, wherein the first value is included in a tensor representing an input into a layer included in a trained neural network.

9. The computer-implemented method of claim 1, wherein the first memory comprises a scratchpad memory.

10. The computer-implemented method of claim 1, wherein storing the one or more memory addresses in the queue comprises storing one or more bits associated with the one or more memory addresses in the queue.

11. A processor comprising:
a first memory; and
circuitry configured to:
store one or more memory addresses at which padding is to be added in a queue,
determine whether a first memory address is stored in the queue,
if the first memory address is stored in the queue, then write a zero to a register,
if the first memory address is not stored in the queue, then write a first value that is read from the first memory to the register, and
perform at least one computation based on the first value that is written to the register to generate an output.

12. The processor of claim 11, wherein the circuitry is further configured to:
generate a second memory address;
determine whether padding is to be added at the second memory address;
if padding is to be added at the second memory address, then add the second memory address to the queue; and
if padding is not to be added at the second memory address, then request a second value that is stored at the second memory address from the first memory.

13. The processor of claim 12, wherein determining whether the second memory address is associated with padding comprises determining whether the second memory address is outside at least one dimension of a tensor.

14. The processor of claim 12, wherein the circuitry is further configured to stall until a response that includes the second value is received from the first memory.

15. The processor of claim 11, wherein the second value is requested while a request for a third value from the first memory is outstanding.

16. The processor of claim 11, further comprising a second memory, wherein the circuitry is further configured to write the first value that is stored in the register to the second memory.

17. The processor of claim 16, wherein the first memory comprises a scratchpad memory, and the second memory comprises a level one (L1) memory.

18. The processor of claim 11, wherein the first value is included in either a first tensor of weights representing a layer included in a trained neural network or a second tensor representing an input into the layer.

19. The processor of claim 11, wherein the processor comprises a graphics processing unit (GPU).

20. A system, comprising:
a memory; and
a processor that is coupled to the memory and configured to perform the steps of:
storing one or more memory addresses at which padding is to be added in a queue,
determining whether a first memory address is stored in the queue,
if the first memory address is stored in the queue, then writing a zero to a register,
if the first memory address is not stored in the queue, then writing a value that is read from the memory to the register, and
performing at least one computation based on the value that is written to the register to generate an output.
